(19) United States
(12) Patent Application Publication
(10) Pub. No.: US 2009/0122979 A1
(43) Pub. Date: May 14, 2009

(54) METHOD AND APPARATUS FOR PROTECTING PATTERN RECOGNITION DATA

(75) Inventors: Yongjin LEE, Ansan (KR); Yun Su CHUNG, Daejeon (KR); Ki Young MOON, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTITUTE, Daejeon (KR)

(21) Appl. No.: 12/261,377

(22) Filed: Oct. 30, 2008

(30) Foreign Application Priority Data
Oct. 30, 2007 (KR) 10-2007-0109614
Oct. 20, 2008 (KR) 10-2008-0102461

(51) Int. Cl. H04L 9/28; G06F 7/06; G06F 17/14; G06F 17/30

(52) U.S. Cl. 380/28; 707/6; 708/400

(57) ABSTRACT

Provided is a data protection technique that converts original data into a secure form so that even if data registered to a system or database is leaked, information relating to original data cannot be exposed from the leaked data. Accordingly, a method of generating a template for protecting data is provided, wherein the method includes: generating a positive numbered (n) registration feature vector g (g=[g₁, g₂, . . . , gₙ]^{T}); generating a positive number m (m<n) low-dimensional coordinates from the registration feature vector; generating at least one chaff coordinates on the m-dimensional coordinate axis with respect to the generated low-dimensional coordinates; and generating a registered template including the low-dimensional coordinates and the chaff coordinates.

### CROSS-REFERENCE TO RELATED PATENT APPLICATIONS

This application claims the benefit of Korean Patent Application No. 10-2007-0109614, filed on Oct. 30, 2007, and Korean Patent Application No. 10-2008-0102461, filed on Oct. 20, 2008, in the Korean Intellectual Property Office, the disclosure of which is incorporated herein in its entirety by reference.

### BACKGROUND OF THE INVENTION

1. Field of the Invention

The present invention relates to a secure data storage and management method in consideration of data variability, and more particularly, to a data protection technique that converts original data into a secure form so that even if data registered to a system or database is revealed, information relating to original data cannot be revealed from the revealed data.

In addition, the present invention relates to a pattern recognition method, where data comparison/recognition is possible in a data converted state, without restoring the original data from the converted data, for secure data management. Also, the present invention relates to a method of converting biometric information on a user into a secure form to protect the biometric information and privacy of the user and a method of recognizing/authenticating the user by using the converted biometric information so that original biometric information on the user cannot be exposed. Moreover, the present invention relates to a data encryption and decryption technique for securely storing and releasing secret information by using biometric data that are unique to each person and can be used for user identification and authentication, but are changed for every acquisition even though acquired from the same person.

The present invention is derived from a research project supported by the Information Technology (IT) Research & Development (R&D) program of the Ministry of Information and Communication (MIC) and the Institute for Information Technology Advancement (IITA) [2007-S-020-01, Development of Privacy Enhanced Biometric System].

2. Description of the Related Art

Pattern recognition is applied in various fields in the modern society. General applications of the pattern recognition include user computer interface techniques such as voice recognition and face recognition, handwriting recognition techniques, automatic spam mail filtering and blocking techniques, web searching techniques, biometrics for user identification, and the like.

In addition, as requirements for automatic analysis of massive data have increased, pattern recognition applications have extended to data mining techniques such as personal consumption pattern analysis for user customized advertisement and automatic health check-up using a user's medical information.

In pattern recognition applications, generally, a template or a model that represents feature data or a data group is created and stored in a system. In addition, the system compares newly input data with the registered template and determines how similar the newly input data and the registered data are or whether or not the newly input data and the registered data are classified into the same class, thereby providing security service.

For example, it is assumed that a handwriting recognition system for recognizing and identifying the letter ‘A’ is provided. The system receives the letter ‘A’ via a user's input in advance, extracts unique features of the letter ‘A’, and generates and stores a template or a model for the letter ‘A’. Thereafter, when a user inputs an arbitrary letter, the system compares the arbitrary letter with the stored template or the model for the letter ‘A’ and calculates a similarity or a dissimilarity therebetween. Then, it is determined whether the similarity or the dissimilarity is larger or smaller than a predetermined value, that is, a threshold, to determine whether or not the letter newly input by the user is the letter ‘A’.

In a case where the similarity is used as a comparison value, if the similarity is larger than the threshold, the letter input by the user is classified as the letter ‘A’, and if the similarity is smaller than the threshold, the input letter is classified as another letter excluding the letter ‘A’. In a case where the dissimilarity is used as the comparison value and Euclidean distance is used for determining the dissimilarity, if the comparison value is smaller than a threshold, the input word is classified as the letter ‘A’, and if the comparison value is larger than the threshold, the input word is classified as another letter excluding the letter ‘A’.

In such method, a template or a model, which is regarded to belong to the same class as input data, or an input entity is designated, and the input data is compared with the designated template through one-to-one matching to determine whether or not the input data belongs to the same class as the template or the model.

Pattern recognition is also used for web-searching, i.e., a recognition technique through one-to-many comparison.

In the web-searching system, information on many homepages is collected in advance, and information on each homepage is summarized, and the summarized information is registered as a template or a model of a corresponding homepage in a database. When a web-searching user inputs a keyword, the web-searching system compares the keyword input by the user with templates or models for the registered homepages and displays a list of templates and models in order of similarity for the user.

In most of the pattern recognition application systems, irrespective of the recognition systems through the one-to-one matching or the one-to-many matching approaches, input data is compared with a registered template as described above, and similarity or dissimilarity is determined by using a comparison value. Specifically, even if pieces of data used in the pattern recognition techniques are acquired from the same person, the same entity, or the same device, the pieces of data do not show the same value but show slightly different values from each other for every data input and acquisition. Therefore, considering whether two pieces of data have exactly the same value cannot be used to determine whether or not the two pieces of data belong to the same class.

In the letter recognition technique described above, even the same user cannot identically write the letter ‘A’ several times. For another example, when a fingerprint is recognized, data on the fingerprint becomes different according to a direction or a pressure of the fingerprint.

When the template or the model registered in the system using the pattern recognition techniques is leaked and abused, serious social and economical problems may occur. For example, it is assumed that a list of purchased goods of a consumer is stored in a database to obtain a consumption pattern of the consumer or for personalized advertisement. The stored data is related to a private consumption pattern of the user. Therefore, when the data is leaked, the consumer's privacy can be intruded. In addition, personal medical information stored for automatic health check-up is more privacy sensitive than the data related to the aforementioned consumption pattern.

A field to which general users may have easier access is the biometrics. A biometric system is a system for identifying a person by using physical/behavioral feature data about the person. Similarly to the general pattern recognition system which generates the template as described above, the biometric system generates and uses a template having physical/behavioral features and information on a user for user registration and identification.

The template registered and stored in the recognition system is referred to as a gallery, and a template that is newly generated from a user who requests authentication is referred to as a probe. When the user requests identification, the biometric system accesses and compares the gallery with the probe and classifies the user as a genuine or an impostor by using a result value of the comparison.

Since the biometric data has unique information on users, similarly to the aforementioned example, intrusion of privacy can occur if such data is disclosed or leaked. Particularly, the biometric data is used as a kind of password for security. Therefore, in a case where a research institute or business uses a security apparatus using the biometric system, if the biometric information is leaked, in addition to the intrusion of privacy, the security of the research or business is threatened. In addition, the number of pieces of biometric data used for user authentication is limited unlike the case of a general password, for example, a human has only one face and ten fingerprints. Thus, the leakage of biometric data is more serious than that of other pattern recognition data.

Therefore, for data that is important or privacy sensitive such as biometric information, a method of encrypting and storing data so as that original information cannot be exposed has been suggested.

However, difficulties arise since it is impossible to obtain the same value from most of the pattern recognition data including the biometric data as described above while, due to characteristics of a cryptographic function, very similar values are encrypted to completely different values.

Therefore, when data that is newly input is encrypted and compared with the data that is encrypted and registered in advance, a comparison value that is generated as a result of the comparison is not consistent with a comparison value obtained by comparing the input data that is not encrypted with original data. Therefore, instead of directly using the encrypted data for pattern recognition, the encrypted data has to be decrypted for comparison and recognition. A method of protecting a registered template with encryption has a disadvantage in that the encrypted and registered template has to be decrypted whenever data comparison is performed, and this results in security vulnerability.

As another method of protecting sensitive data such as a password, a method using a hash function has been proposed. In this method, in an authentication system generally using a password, the password of a user is not directly compared for authentication, but a hashed password is stored in advance, and the hashed password is compared with a hashed password input for authentication. However, as described above, the same value cannot be generated from most data including biometric information used for pattern recognition even though the pieces of data are input from the same person, the same entity, or the same device, but quite different result values are generated from similar input values through the hash function. Therefore, pattern recognition using hashed templates is not accurate.

Difficulties of the existing encryption technique to protect the pattern recognition data due to data variability are associated with biometric-based key management combining the general encryption system and the biometric system.

In a general encryption-based user authentication and security system, the user is authenticated or data is encrypted by using a password or a private key of the user. It is well known that a long password or a long private key that is randomly generated has to be used to obtain high security. However, it is very difficult for the user to always remember the long password accurately.

In order to solve the aforementioned problem, by using a short and simple password that the user can easily remember, an original long and complex password or a private key is encrypted, and as needed, the original long and complex password or the private key is decoded to be used for a general encryption operation.

As another method, an original long and complex password or a private key is stored in a personal storage device such as a smartcard, and the password or the private key is released to be used, as needed. However, there is a security problem when the smartcard is lost.

Due to practical limitations of remembering and managing the long password or the private key for the user, a general authentication and encryption system is dependent on an apparatus having a low security level, and thus, the security level of the entire system decreases.

However, instead of using a password that the user may forget or a smartcard that can be lost, if the biometric information is used to manage and protect the password or the private key, the user key management problem that occurs in the aforementioned existing encryption and security system may be solved.

As a method of applying biometrics to the user key management of the existing encryption system, a biometric-based key release method has been proposed. The biometric-based key release method uses biometric information on the user to authenticate the user and as a result of the authentication, when the user is identified as a genuine, security information such as a password or a private key of a corresponding user is released from a smartcard, a system, or a database.

The aforementioned method has an advantage in that the biometric method and the encryption system can be easily combined and implemented. However, since biometric information registered for user authentication and the security information such as the password or the private key are separated logically or physically from each other to be stored in the system, a security problem may still occur. A hacker may directly steal only the password or the private key used for the encryption operation without attacking the biometric system and may exploit the password or the private key. Therefore, basically, the biometric-based key release method may not protect the security information such as the password or the private key securely. In addition, similar to the general biometric system, there is a problem in that the biometric information on users registered in the system may be exposed.

Therefore, as an ideal method, the biometric information on the user is used as a cryptographic key so as to encrypt and store the long and complex password or the private key used for the general encryption operation and as needed, the encrypted password or private key is decoded using the biometric information on the user so as to use the decoded long and complex password or the personal key for the general encryption operation such as encryption/decryption.

However, although the biometric information is acquired from the same user or the same device, values of the acquired data are not fixed but different from each other every time. The hash function or the encryption/decryption techniques used in the existing encryption-based security system generate completely different output values from similar input values. Therefore, as described above, directly using the biometric information as the key in the existing encryption method is not possible.

### SUMMARY OF THE INVENTION

The present invention provides a secure data storage and management method in consideration of data variability.

Specifically, the present invention provides a data protection technique that converts original data into a secure form so that even if data registered to a system or database is leaked, information relating to original data cannot be exposed from the leaked data.

The present invention also provides a pattern recognition method, where data comparison/recognition is possible in a data converted state, without restoring the original data from the converted data, for secure data management.

The present invention also provides a data encryption and decryption method of securely storing and releasing secret information by using a variable value, instead of a fixed value.

The present invention also provides a method of converting biometric information on a user into a secure form to protect the biometric information and privacy of the user and a method of recognizing/authenticating the user by using the converted biometric information so that original biometric information on the user cannot be exposed.

The present invention also provides a data encryption and decryption technique for securely storing and releasing secret information by using biometric data that is unique to each person and can be used for user identification and authentication, but is changed for every acquisition even though acquired from the same person.

According to an aspect of the present invention, there is provided a method of generating a template for protecting data, the method including: generating a positive numbered (n) registration feature vector g (g=[g₁, g₂, . . . , gₙ]^{T}); generating a positive number m (m<n) low-dimensional coordinates from the registration feature vector, wherein the positive number is smaller than the positive number n; generating more than one chaff coordinates on the m-dimensional coordinate axis with respect to the generated low-dimensional coordinates; and generating a registered template including the low-dimensional coordinates and the chaff coordinates.

### BRIEF DESCRIPTION OF THE DRAWINGS

The above and other features and advantages of the present invention will become more apparent by describing in detail exemplary embodiments thereof with reference to the attached drawings in which:

FIG. 1 is a graph illustrating an example of a genuine comparison values distribution and an impostor comparison values distribution in pattern recognition;

FIG. 2 is a diagram for explaining a relationship between a threshold and a decision boundary in a two-dimensional feature space;

FIG. 3 is a diagram for explaining a relationship between a threshold and a decision boundary in a three-dimensional feature space;

FIG. 4 illustrates a decision boundary sphere having a radius of 0 and the center at the gallery g in a three-dimensional feature space, according to an embodiment of the present invention;

FIG. 5 illustrates 2-low dimensional coordinates derived from a four-dimensional feature vector g in a two-dimensional space;

FIG. 6 illustrates arbitrary chaff coordinates generated to conceal low dimensional coordinates derived from a feature vector g;

FIG. 7A illustrates an example of a registered template generated from a four-dimensional feature vector according to an embodiment of the present invention;

FIG. 7B illustrates an example of a hash value further added and stored to a registered template generated from a four-dimensional feature vector according to an embodiment of the present invention;

FIG. 8A illustrates an example of a registered template generated from a five-dimensional feature vector according to an embodiment of the present invention;

FIG. 8B illustrates an example of a hash value further added and stored to a registered template generated from a five-dimensional feature vector according to an embodiment of the present invention;

FIG. 9 illustrates an example of a registered template for securely storing secrete information using low dimensional coordinates induced from a basic gallery feature vector of the registered templates as in FIG. 7A;

FIG. 10 illustrates a case where real regions are overlapped by low dimensional coordinates according to an embodiment of the present invention;

FIG. 11 illustrates an example of transforming coordinates through a transformation function when the real region induced from a feature vector g are overlapped according to an embodiment of the present invention;

FIG. 12 illustrates an example of generating chaff coordinates so as to conceal transformed real coordinates according to an embodiment of the present invention;

FIG. 13 illustrates an example of transforming low dimensional coordinates of a probe feature vector by a transformation function for comparison and authentication, when the probe feature vector is input according to an embodiment of the present invention;

FIG. 14A illustrates an example where low dimensional coordinates induced from a feature vector use each different coordinate space according to an embodiment of the present invention;

FIG. 14B illustrates registered templates including low dimensional coordinates using each different coordinate space according to an embodiment of the present invention;

FIG. 15 is a flowchart illustrating a method of generating a registered template according to an embodiment of the present invention;

FIG. 16 is a flowchart illustrating a method of classifying whether input data is a genuine or an imposter when data to be compared is input according to an embodiment of the present invention; and

FIG. 17 is a block diagram of a pattern recognition apparatus according to an embodiment of the present invention.

### DETAILED DESCRIPTION OF THE INVENTION

Hereinafter, a secure pattern recognition method and apparatus according to the present invention will be described in detail with reference to the attached drawings. In the description, the detailed descriptions of well-known technologies and structures may be omitted so as not to hinder the understanding of the present invention. In addition, terms in the present invention are defined in consideration of functions according to the present invention and may be changed according to an intention of a user or an operator or a usage. Therefore, definitions of the terms should be construed based on the description of the specification.

It should be noted that terms from biometric technology are used for the convenience of description, because the technical concepts and terms from biometric technology among pattern recognition applications are well defined. The present invention is not limited to the field of biometrics, and the principle of the present invention is described by using terms from biometric technology so that the principle of the present invention can be easily applied to other fields through examples of the description.

The invention is described in detail as in the following order.

First, for clearer and easier description for a basic principle of the invention, a decision equivalence principle and related terms are described.

Second, a method of converting original data into a secure form and a method of generating a secure template are described so that even if data registered in a system or database is revealed, information related to the original data cannot be exposed from the revealed data.

Third, a method of comparing/recognizing data in a data converted state based on the decision equivalence principle and a proposed template, without restoring the original data from the converted data, for secure data management, is described. When the proposed method is used, biometric information on a user is converted into a secure form to protect the biometric information and privacy of the user so that original biometric information on the user cannot be exposed and then, user recognition/authentication using the converted biometric information is possible.

Fourth, a data encryption and decryption method of securely storing and releasing secret information by using a variable value, instead of a fixed value, is described. When the proposed method is used, data such as biometric data, that is unique to each person and can be used for user identification and authentication, but is changed for every acquisition even though acquired from the same person, can be used to securely store and release secret information.

Fifth, solutions for problems which may occur when the proposed methods of converting data into a secure form and generating a template are actually realized and a method of increasing security level are additionally described.

For the convenience of description, a template registered and stored in a pattern recognition system is referred to as a gallery, and a template generated from data that is newly input to be recognized is referred to as a probe.

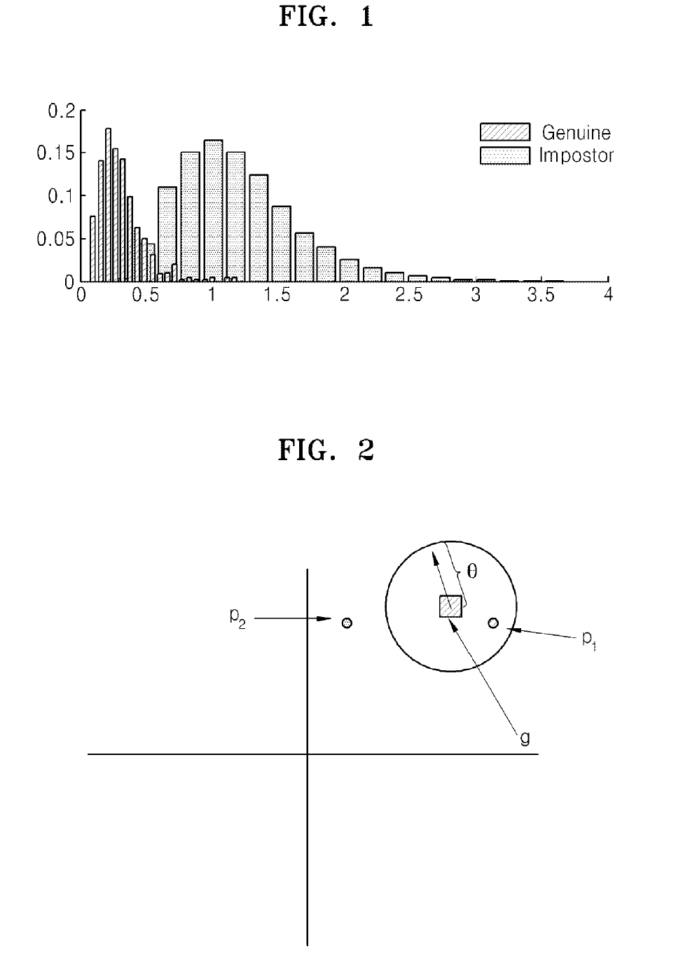

FIG. 1 is a graph illustrating an example of a genuine comparison value distribution and an impostor comparison value distribution in pattern recognition.

The genuine comparison value distribution is denoted as a comparison value distribution generated by comparing galleries and probes that belong to the same class, and the impostor comparison value distribution is denoted as a comparison value distribution generated by comparing galleries and probes that belong to different classes from each other.

In biometrics, FIG. 1 illustrates an example of the genuine comparison value distribution and the impostor comparison value distribution. A Euclidean distance is used as the comparison value and thus most of the genuine comparison values are smaller than the impostor comparison values.

There is a point at which a distribution of the genuines and a distribution of the impostors are equal, and a distribution value at this point is referred to as an equal error rate (EER). At this point, a false rejection rate (FRR), which is a rate of classifying a gallery and a probe that belong to the same class into different classes, and a false acceptance rate (FAR), which is a rate of classifying a gallery and a probe that belong to different classes into the same class, are equal.

In general, this point is referred to as a threshold θ, and when a comparison value between a gallery and a probe is smaller than the threshold θ, the gallery and the probe are classified into the same class, and when the comparison value is larger than the threshold θ, the gallery and the probe are classified into different classes. This is explained by the same principle in that the probe is determined as genuine when the comparison value is smaller than the threshold θ and determined as the impostor when the comparison value is larger than the threshold θ in the biometric system. It is not necessary to set the value of the threshold θ based on EER and it can be adjusted in order to properly control the FRR and the FAR according to a system application.

The threshold θ for classifying the genuine and the impostor has a meaning of a decision boundary in a feature space. The decision boundary is described in detail with reference to FIG. 2.

FIG. 2 is a diagram for explaining the relationship between the threshold θ and the decision boundary in a two-dimensional feature space. In FIG. 2, g denotes a gallery, and p₁ and p₂ denote probes.

It is assumed that the threshold for determining the genuine and the impostor is set to θ, and a template for recognition is a two-dimensional real-valued vector. In this case, as illustrated in FIG. 2, a circle, which has a radius θ and the center at a registered template, that is, the gallery g, is the decision boundary.

Specifically, in a case where recognition is requested, if the comparison value between the probe and the gallery is smaller than θ, the probe is classified into the same class (that is, the probe is genuine) as the gallery, and if the comparison value is larger than θ, the probe is classified into a different class (that is, the probe is an impostor) from the gallery. This also can be explained by the same principle in that a probe inside the circle having the center at the gallery g and the radius θ is classified into the same class (the probe is referred to as genuine) as the corresponding gallery g and a probe outside the circle having the radius θ is classified into a different class (the probe is referred to as an impostor) in the feature space.

Since the probe p₁ is inside the circle having the radius θ and the center at the gallery g, the probe p₁ is classified into the same class (the probe is referred to as genuine) as the gallery, and a comparison value between the probe p₁ and the gallery g is smaller than the threshold θ. For another example, since the probe p₂ is outside the circle having the radius θ and the center at the gallery g, the probe is classified into a different class (the probe is referred to as impostor) from the gallery, and a comparison value between the probe p₂ and the gallery g is larger than the θ.

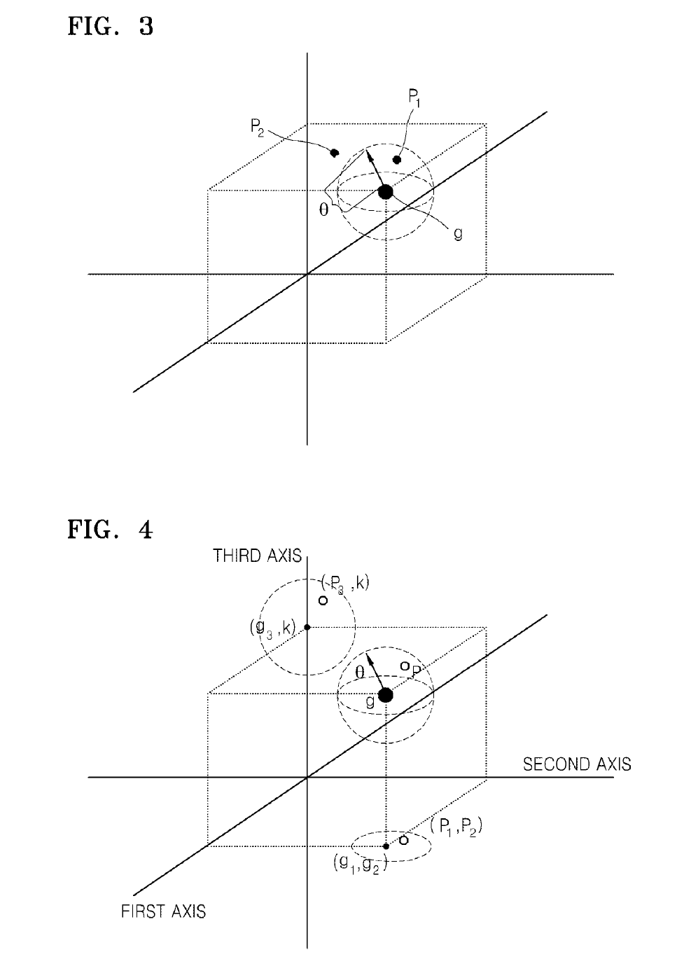

For clearer description, a case where a template for recognition is a three-dimensional real-valued vector is described as follows. In FIG. 3, g denotes a gallery, and p₁ and p₂ denote probes.

Since the probe p₁ is inside the sphere having the radius θ and the center at the gallery g, the probe p₁ is classified into the same class (the probe is referred to as genuine) as the gallery, and a comparison value between the probe p₁ and the gallery g is smaller than the threshold θ. In addition, since the probe p₂ is outside the sphere having the radius θ and the center at the gallery g, the probe is classified into a different class (the probe is referred to as impostor) from the gallery, and a comparison value between the probe p₂ and the gallery g is larger than the θ. For the convenience of description, two-dimensional and three-dimensional data are exemplified. In a high-dimensional (more than four) space, the same principle is applied.

For the convenience and accuracy of description, low-dimensional coordinates, which are m-dimensions, for an n-dimensional feature vector (m<n) are defined as an example below. When an original feature template for recognition is a three-dimensional (n=3) vector g as follows,

g=[g₁, g₂, g₃]^{T}

low dimensional coordinates, in which m=1, are formed of three one-dimensional coordinates below.

(g₁), (g₂), (g₃)

low dimensional coordinates, in which m=2, are as follows.

(g₁, g₂), (g₃, k)

Here, k is an arbitrary value inserted for correcting a number of elements of low dimensional coordinates.

When low-dimensional coordinates, which are m-dimensions, for an n-dimensional feature vector, are generated, elements of the n-dimensional feature vector may be repeatedly used as follows. However, for simplicity in description, hereinafter, the elements of the n-dimensional feature vector may not be repeatedly used as follows.

(g₁, g₂), (g₂, g₃), (g₃, g₁)

When an original feature template for recognition is a four-dimensional vector g,

g=[g₁, g₂, g₃, g₄]^{T}

2-low dimensional coordinates are as follows.

(g₁, g₂), (g₃, g₄)

For a better understanding, a ‘decision equivalence principle’ is described as follows.

FIG. 4 illustrates a decision boundary sphere having the radius θ and the center at the gallery g in a three-dimensional feature space. In FIG. 4, g denotes a gallery and p denotes a probe. Also, (g₁, g₂) and (g₃, k) denote 2-low dimensional coordinates for the gallery g, and (p₁, p₂) and (p₃, k) denote 2-low dimensional coordinates for the probe p. In this case, k is θ in FIG. 4. The decision equivalence principle is described with reference to FIG. 4.

If the probe p is inside the sphere having the radius θ and the center at the gallery g, (p₁, p₂) is inside the circle having the radius θ and the center at (g₁, g₂) and (p₃, k) is inside the circle having the radius θ and the center at (g₃, k), and the distance between the coordinates (g₁, g₂, g₃, k) and (p₁, p₂, p₃, k) created by connecting the low-dimensional coordinates is smaller than θ.

Inversely, if (p₁, p₂) is inside the circle having the radius θ and the center at (g₁, g₂), (p₃, k) is inside the circle having the radius θ and the center at (g₃, k), and the distance between the coordinates (g₁, g₂, g₃, k) and (p₁, p₂, p₃, k) created by connecting the low-dimensional coordinates is smaller than θ, p is inside the sphere having the radius θ and the center at the gallery g.

As such, the decision equivalence principle may be defined as follows using the four-dimensional feature vector g and the probe vector p, as an example.

g=[g₁, g₂, g₃, g₄]^{T}

p=[p₁, p₂, p₃, p₄]^{T}

If the probe p is inside the sphere having the radius θ and the center at the gallery g, (p₁, p₂) is inside the circle having the radius θ and the center at (g₁, g₂) and (p₃, p₄) is inside the circle having the radius θ and the center at (g₃, g₄), and the distance between the coordinates (g₁, g₂, g₃, g₄) and (p₁, p₂, p₃, p₄) created by connecting the low-dimensional coordinates is smaller than θ.

Inversely, if (p₁, p₂) is inside the circle having the radius θ and the center at (g₁, g₂), (p₃, p₄) is inside the circle having the radius θ and the center at (g₃, g₄), and the distance between the coordinates (g₁, g₂, g₃, g₄) and (p₁, p₂, p₃, p₄) created by connecting the low-dimensional coordinates is smaller than θ, p is inside the sphere having the radius θ and the center at the gallery g.

The ‘decision equivalence principle’ is described to show that an existing pattern recognition genuine/impostor decision method for classifying whether the comparison values between the gallery and the probe is smaller or larger than the threshold θ is equivalent to the comparison/recognition method for examining whether or not the low-dimensional coordinates of the probe feature vector belong to a region for determining the genuine defined by the low-dimensional coordinates of the gallery feature vector.

The general decision equivalence principle is described as follows in connection with the existing pattern recognition genuine/impostor decision method for classifying whether the comparison values between the gallery and the probe is smaller or larger than the threshold θ.

If the probe p is inside the sphere having the radius θ and the center at the gallery g, the low-dimensional coordinates of the probe p is inside the sphere or the circle having the radius θ and the center at the corresponding low-dimensional coordinates of the gallery g. In addition, the distance between the coordinates created by the low-dimensional coordinates of the probe p and the coordinates created by the low-dimensional coordinates of the gallery g is smaller than θ.

Inversely, if the low-dimensional coordinates of the probe p is inside the sphere or the circle having the radius θ and the center at the corresponding low-dimensional coordinates of the gallery g, and the distance between the coordinates created by the low-dimensional coordinates of the probe p and the coordinates created by the low-dimensional coordinates of the gallery g is smaller than θ, the probe p is inside the sphere having the radius θ and the center at the gallery g.

A method of converting original data into a secure form and a method of generating a secure template are described as follows so that even if data registered to a system or database is leaked, information related to the original data cannot be exposed from the leaked data.

For the convenience of description, a four-dimensional feature vector is described as an example.

g=[g₁, g₂, g₃, g₄]^{T}

It is assumed that the registered template g and 2-low dimensional coordinates are as follows.

(g₁, g₂), (g₃, g₄)

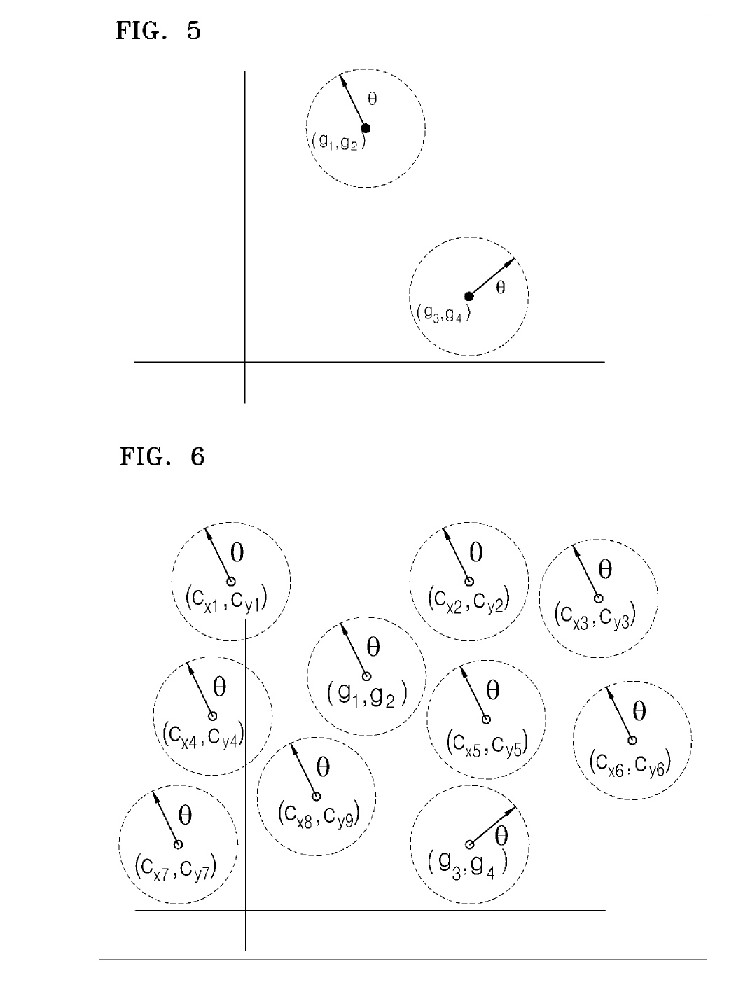

FIG. 5 illustrates the 2-low dimensional coordinates for the four-dimensional feature vector g represented in a two-dimensional space.

In addition, FIG. 6 illustrates arbitrary chaff coordinates generated to conceal the low-dimensional coordinates induced from the feature vector g.

The arbitrary chaff coordinates are inserted into the registered template. For the convenience of description, the low-dimensional coordinates (g₁, g₂), (g₃, g₄) induced from the feature vector g are called as real coordinates and the low-dimensional coordinates (cₓ₁, c_{y1}), (cₓ₂, c_{y2}), (cₓ₃, c_{y3}), (cₓ₄, c_{y4}) inserted to conceal the low-dimensional coordinates induced from the feature vector g are called as chaff coordinates. In addition, the circle or the sphere having the radius θ and the center at the real coordinates denotes a real region and the circle or the sphere having the radius θ and the center at the chaff coordinates denotes an chaff region.

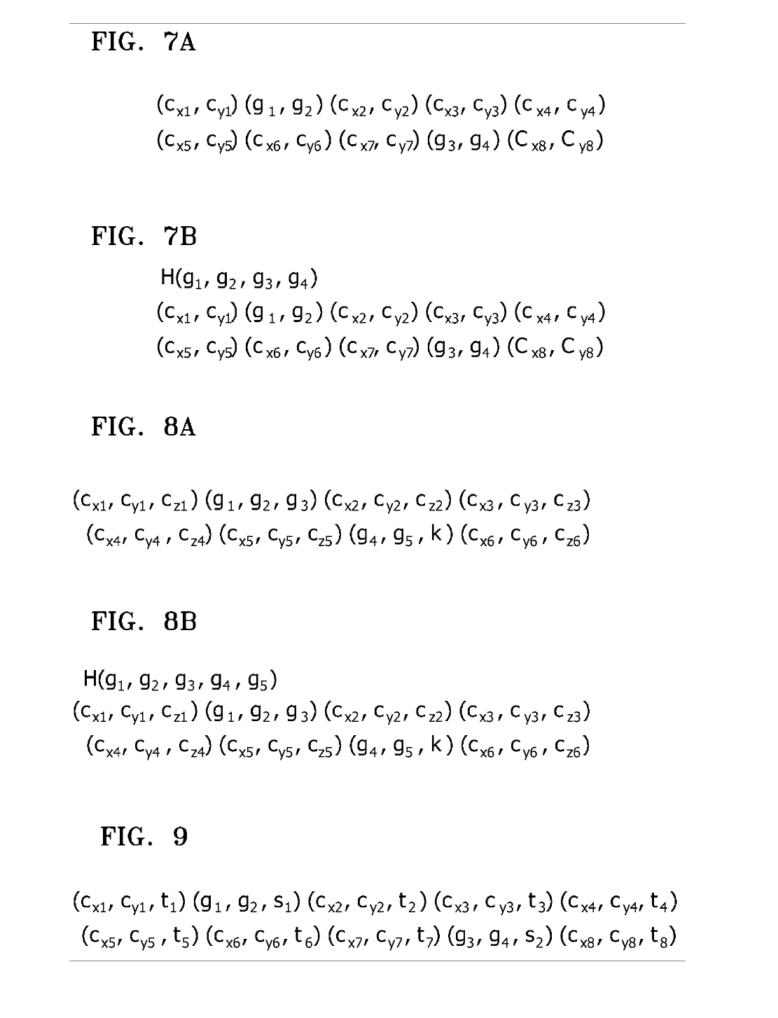

Since FIG. 6 is described conceptually for better understanding, the template may have a structure as in FIG. 7A.

FIG. 7A illustrates the registered template formed of the 2-low dimensional real coordinates and the chaff coordinates for the four-dimensional feature vector g.

It is very hard to find out accurate original feature information g from the proposed registered template. In FIGS. 6 and 7A, two low-dimensional coordinates induced from the four-dimensional feature vector and eight arbitrary chaff coordinates to conceal the two low-dimensional coordinates are inserted into the registered template. It is assumed that fifty 2-low dimensional coordinates induced from a hundred-dimensional feature vector and fifty chaff coordinates are inserted, in consideration of an actual application. Here, the possible number of cases is 100!/50!=2³¹⁰. That is, possible combination numbers for finding out the original feature vector g substantially increase by the dimension of the original feature vector and the inserted chaff coordinates. Thus, when the proposed method of converting data is used, original data may be securely protected.

FIG. 7B illustrates the registered template of FIG. 7A further including a hash value for the values induced from the four-dimensional feature vector g, in order to compare the templates for pattern recognition and user authentication.

The proposed pattern recognition using secure template and a method of comparing the template for user authentication are described as follows.

In FIG. 7B, H(g₁, g₂, g₃, g₄) denotes the hash value of g. For the convenience of description, the hash value for g itself is used and in some cases, other values related to g may be used. In addition, in order to make it more difficult to guess a preimage of a hash value, g may be combined with arbitrary data and the combined g may be used to produce a hash value.

Here, the hash value is of g, for convenience of description. When the probe feature vector p is input, low-dimensional coordinates are generated as in the gallery feature vector g. When it is assumed that the input probe feature vector is as follows,

p=[p₁, p₂, p₃, p₄]^{T}

2-low dimensional coordinates of the probe feature vector p are generated as follows,

(p₁, p₂), (p₃, p₄)

Then, in FIG. 7B, the center point of the region to which (p₁, p₂) belongs and the center point of the region to which (p₃, p₄) belongs should be found out. Then, the hash value of the found point combinations is calculated and the calculated hash value is compared with the hash value stored in FIG. 7B. In addition, whether the distance between p and high-dimension coordinates formed of center point coordinates to which the low-dimensional coordinates of p belong is smaller than θ is examined. If both hash values are equal and the distance between p and high-dimension coordinates formed of center point coordinates to which the low-dimensional coordinates of p belong is smaller than θ, p is classified into the same class (genuine) as the registered template. If both hash values are equal, the low-dimensional coordinates induced from p are inside the real region. Thus, due to the ‘decision equivalence principle’ defined as above, the result of classification is the same as the existing pattern recognition decision method for determining the genuine and the imposter using pre-calculated threshold after obtaining a comparison value of two templates.

In addition, the result of classification is same as the method of determining the genuine or the imposter in the general biometric system. That is, when the proposed method is applied, it is possible to realize the performance of recognition that is same as that of the existing pattern recognition technique with original data being securely stored. Checking whether the distance between p and high-dimension coordinates formed of the center point coordinates to which the low-dimensional coordinates of p belong is smaller or larger than θ is to make the result of recognition consistent with the existing pattern recognition method. For an efficient configuration of the system, it may be omitted.

In addition, if necessary, the size of the real region and the chaff region may be selected from values other than θ. However, in order to accurately maintain recognition rate, it is more desirable to set sizes of the real region and the chaff region to θ and to examine whether the distance between p and high-dimension coordinates formed of center point coordinates to which the low-dimensional coordinates of p belong is smaller or larger than θ.

FIG. 8A illustrates the registered template formed of 3-low dimensional real coordinates and chaff coordinates for a five-dimensional feature vector g. Even if the number of the dimension increases, the decision equivalence principle may be applied in the same manner as in FIGS. 7A and 7B. Two low-dimensional coordinates formed of three elements are generated and an arbitrary value k is added to one coordinate, in order to match the number of the elements.

FIG. 8B illustrates the registered template of FIG. 8A further including a hash value for the values induced from the five-dimensional feature vector g, in order to compare the templates for pattern recognition and user authentication.

When the principle of the present invention and the proposed template are applied, a variable value, instead of a fixed value, may be used as a cryptographic key, and secret information may be encrypted and decrypted.

Accordingly, the secret information such as password or private key may be securely stored and released using biometric information that is variable but is unique to each person.

FIG. 9 illustrates an example of a registered template for securely storing secrete information using low dimensional coordinates induced from a basic gallery feature vector of the registered templates as in FIG. 7A.

As illustrated in FIG. 9, an arbitrary value is additionally stored in the chaff coordinates that are inserted to conceal the low-dimensional coordinates induced from the gallery feature vector. In FIG. 9, c, g, t, and s respectively denote center coordinates of the chaff region, coordinates of the real region, arbitrary values, and secret information to be securely stored.

In order to release the secret information s from the registered template, information unique to each person such as user's own biometric information is input and the probe feature vector is generated. Then, in the system, the center point of the region, to which low-dimensional coordinates induced from the user probe feature vector belong, is found in the registered template that is created as in FIG. 9 using the center point coordinate of the stored region. In addition, it is examined whether the distance between the probe feature vector and the point combinations of the region to which the low-dimensional coordinates of the probe feature vector belong is smaller or larger than θ. If the distance is smaller than θ, a value connected to the center point coordinate of the region to which low-dimensional coordinates induced from the probe feature vector belong (here, the secret information) returns to the user.

Then, as described above, according to the ‘decision equivalence principle’, the accurate secret information may be found from the registered template only when the user is recognized as genuine by the existing biometric methodology and the biometric recognition method.

Here, checking whether the distance between the probe and high-dimensional coordinates formed of the center point coordinates to which the low-dimensional coordinates of the probe belong is smaller than θ is to match the recognition result accurately with that of the existing pattern recognition method. However, for efficiency of the system, such checking may be omitted and the system may only send back values matched in the region to which the low-dimensional coordinates of the probe belong. In addition, if necessary, the sizes of the real region and the chaff region may have values other than θ and may be compared to each other.

However, in order to accurately maintain recognition rate, it is more desirable to set sizes of the real region and the chaff region to θ and to examine whether the distance between p and high-dimension coordinates formed of center point coordinates to which the low-dimensional coordinates of p belong is smaller or larger than θ.

Hereinafter, solutions to problems which may occur when the proposed methods of securely converting data and generating the template are realized and a method of increasing the security level are additionally described.

In the method of generating a secure template described above, a size of the real region is set to the threshold θ obtained after genuine and impostor comparison values distribution analysis, in order to match the recognition result with the existing pattern recognition method. However, a size of the real region may be relatively large in a low-dimensional coordinate space. In this case, the number of the chaff coordinates, which can efficiently conceal the real coordinates, may be limited.

Hereinafter, a method of appropriately calculating the radius of the real region is described. The detail of the description is a kind of guideline. The radius of the real region and the chaff region may be actually adjusted to various sizes and sizes of each region may be different to each other.

The threshold θ determined by the genuine and impostor comparison value distribution analysis may be the maximum allowable expected distance between the gallery and the probe that belong to the same class. It can be interpreted that the distance between the given gallery and the probe that belong to the same class is smaller than θ, statistically, and such value θ is regarded as a reference value so as to classify the probe into the genuine or impostor. This is expressed as in Equation below.

$$\begin{matrix}E [ {‖ g - p ‖}^{2} ] = E [ {( g - p )}^{T} ( g - p ) ] \\ = E [ {( {g}_{1} - {p}_{1} )}^{2} ] + E [ {( {g}_{2} - {p}_{2} )}^{2} ] + … + E [ {( {g}_{d} - {p}_{d} )}^{2} ] \\ = {σ}_{1}^{2} + {σ}_{2}^{2} + … + {σ}_{d}^{2} \\ \leq {θ}^{2}\end{matrix}$$

Here, E denotes a symbol for an expectation value and d denotes the dimension of the gallery and the probe. Also, σᵢ²=E[(gᵢ−pᵢ)²]. That is, σᵢ² is a squared expectation distance between the gallery and the probe on an i-dimension axis, and as another meaning, σᵢ² is the variance of pᵢ at the center of gᵢ. i denotes i^{th} dimensional axis or i^{th} element.

It can be assumed that p has an isometric Gaussian distribution (where a variance matrix is a diagonal matrix and all values of diagonal elements are same) at the center of g. Actually, according to the Bayesian decision theory, using a Euclidean distance in data comparison is a tacit hypothesis that data distribution is an isometric Gaussian distribution. When data has an isometric distribution, the Euclidean distance is the optimum comparison value, in terms of the recognition rate.

If the data distribution is a general Gaussian distribution, using a Mahalanobis distance may be preferred, instead of the Euclidean distance, according to the Bayesian decision theory. Comparing two data using the Mahalanobis distance with respect to the general Gaussian distribution data may be equivalent to whitening the data distribution and then using the Euclidean distance. That is, it is easy to convert the data in the general Gaussian distribution data into isometric Gaussian distribution data and this does not make the recognition rate worse, theoretically. Accordingly, for the convenience of description, it is assumed that the probe p has the isometric Gaussian distribution and the center at the gallery g. Chapter 2 in Pattern Classification (Second Edition, Richard O. Duda, Peter E Hart, David G. Stork, 2001, Wiley Interscience) may be the reference for more detailed description.

In the case of the isometric Gaussian distribution, distribution of all dimensional axis is equal. Thus, the above equation may be arranged as follows.

$$\begin{matrix}{θ}^{2} \geq {σ}_{1}^{2} + {σ}_{2}^{2} + … + {σ}_{d}^{2} \\ = {σ}^{2} + {σ}^{2} + … + {σ}^{2} \\ = d {σ}^{2}\end{matrix}$$

σ and θ respectively denote the variance and the distance and thus, have positive values as shown below.

$$σ \leq \frac{1}{\sqrt{d}} θ$$

That is, statistical expectation that the distance between the gallery g and the probe p is smaller than θ is equivalent to expectation that the distance between the elements of g and p is smaller than

$$\frac{1}{\sqrt{d}} θ .$$

Thus, the radius r in the real region of dₛ-low dimensional coordinates for d-dimensional feature vector may be uniformly set as shown below.

$$r = \frac{\sqrt{{d}_{s}}}{\sqrt{d}} θ$$

Here, dₛ denotes the dimension of the low dimensional coordinate.

Hereinafter, a case where the real regions are overlapped is considered.

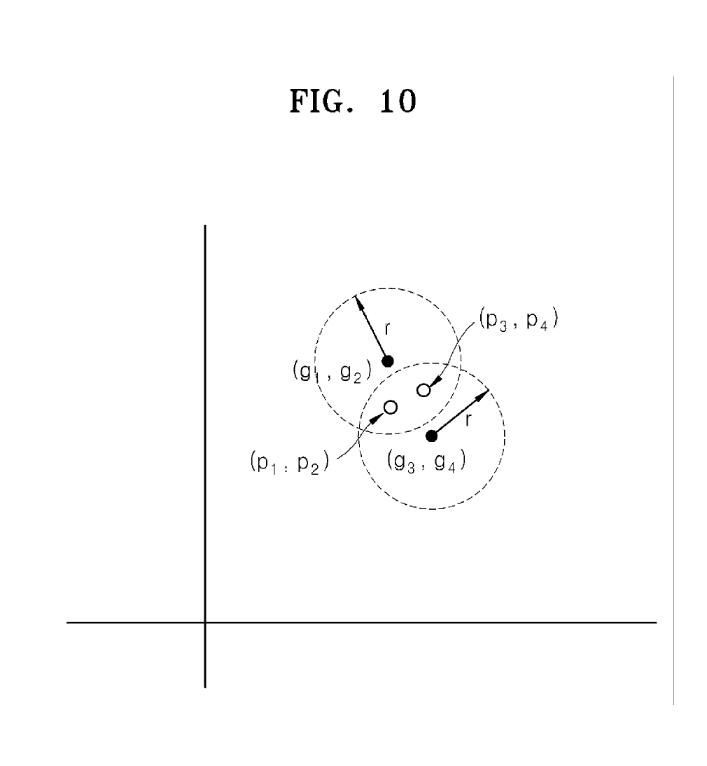

FIG. 10 illustrates a case where the real regions are overlapped by the low dimensional coordinates according to an embodiment of the present invention.

In the description for the method of generating the secure template with reference to FIGS. 5 and 6, the real regions induced from the gallery feature vector g are not overlapped with each other. However, the real regions may be overlapped as in FIG. 10.

The low-dimensional coordinates induced from the probe feature vector may belong to a portion in which the real regions induced from the gallery feature vector g are overlapped. In this case, it is hard to determine where (p₁, p₂) and (p₃, p₄) belong.

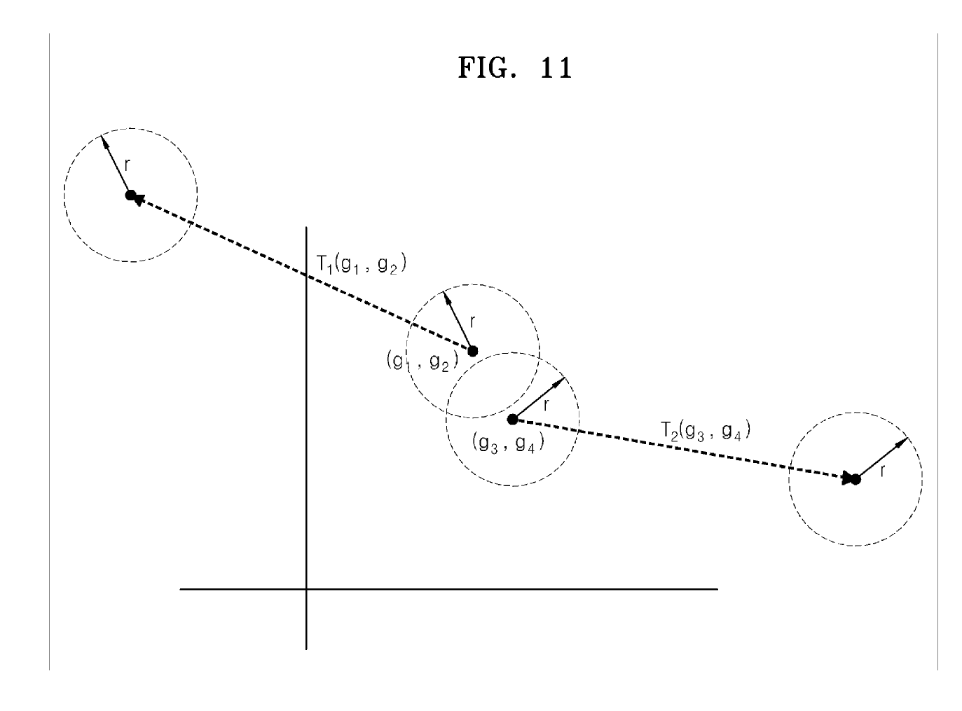

FIG. 11 illustrates an example of transforming the coordinates through a transformation function when the real regions induced from the feature vector g are overlapped according to an embodiment of the present invention.

As in FIG. 11, when the template is registered, (g₁, g₂) is changed to new transformed coordinates using a transformation function T₁. Similarly, a transformation function T₂ is used to move (g₃, g₄) to new transformed coordinates. Then, the transformed coordinates are not overlapped with each other and thus, genuine/impostor comparison according to the methods described above is possible.

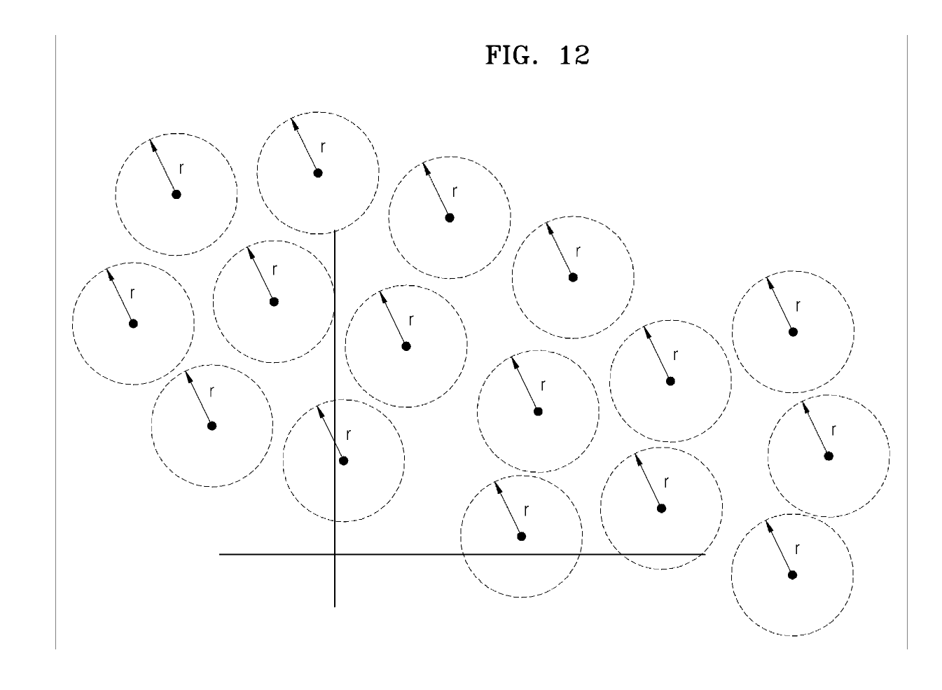

FIG. 12 illustrates an example of generating chaff coordinates so as to conceal the transformed coordinates.

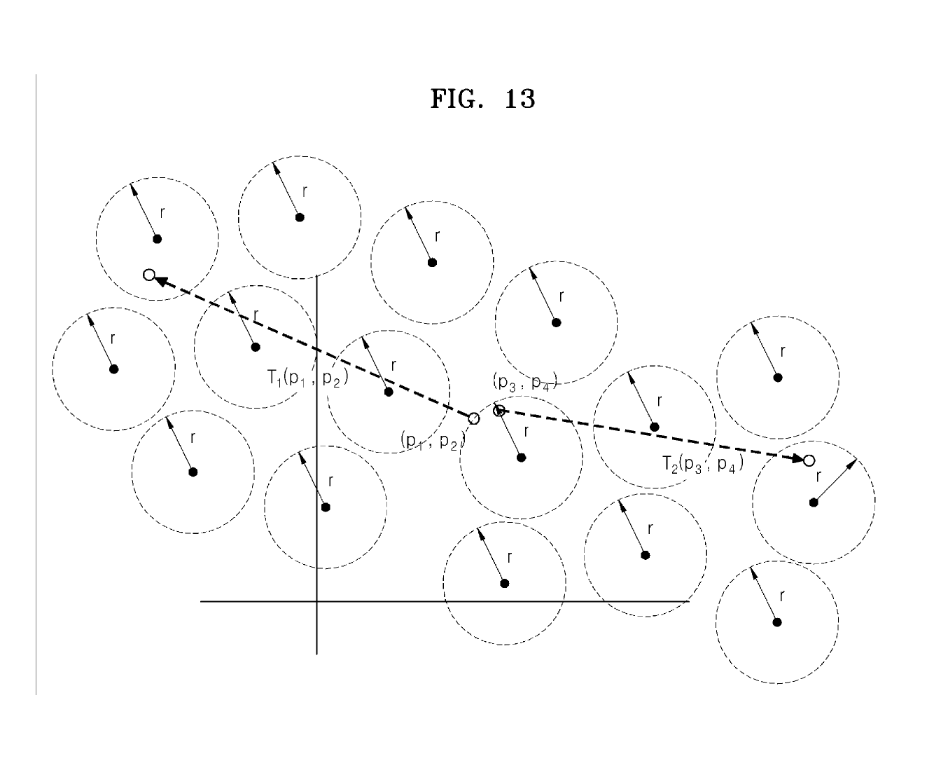

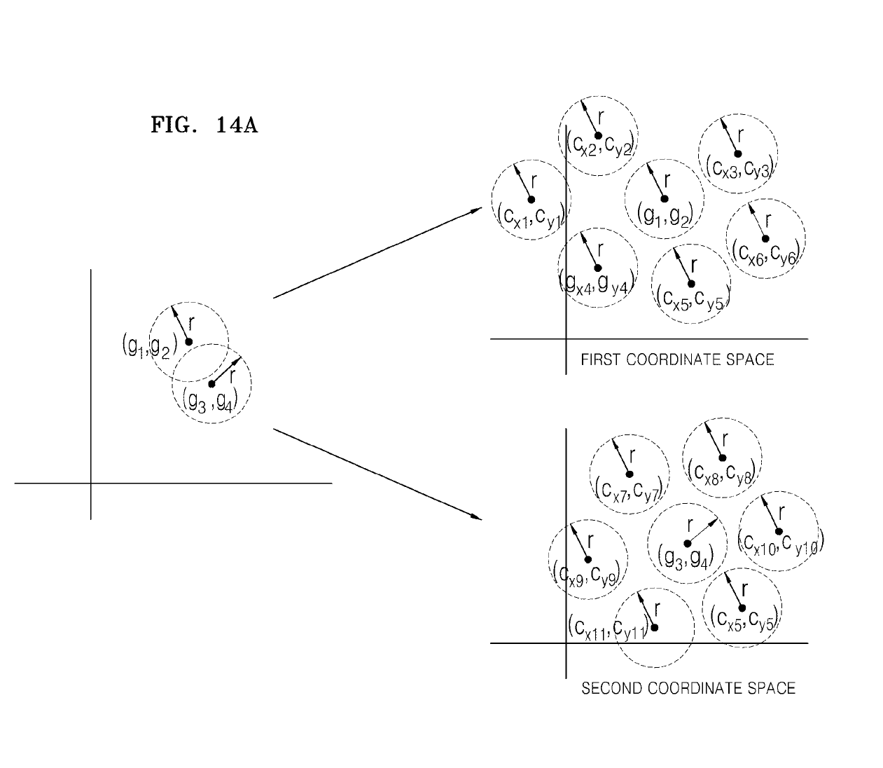

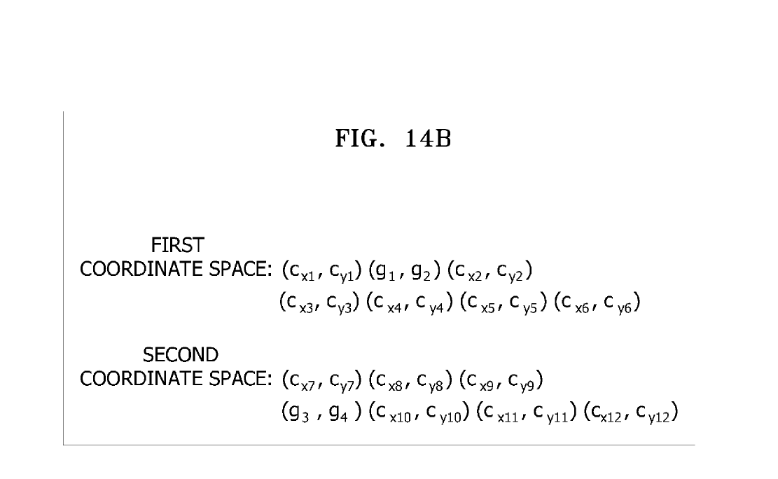

FIG. 13 illustrates an example of transforming low-dimensional coordinates of the probe feature vector by the transformation function for comparison and authentication, when the probe feature vector is input according to an embodiment of the present invention.

When the probe feature vector is input for comparison and authentication, the low-dimensional coordinates are generated from the probe feature vector. (p₁, p₂) from among the generated low-dimensional coordinates is transformed by the transformation function T₁ and (p₃, p₄) is transformed by the transformation function T₂. Also, as mentioned above, the region to which the low-dimensional coordinates induced from the probe feature vector belong is found to perform comparison and authentication.

Here, the transformation functions T₁ and T₂ used to transform the coordinates can be stored in the system as in the proposed secure template. However, for security reasons, the transformation functions T₁ and T₂ may be stored as user private information. For example, information related to the transformation functions may be stored in a personal storage device such as a smart card or may be generated based on a password set by the user.

The transformation functions are not limited. However, for the efficiency of the system, affine transformation formed of an orthogonal matrix Aᵢ and a random vector bᵢ may be used for the transformation function.

Tᵢ(gᵢ)=Aᵢgᵢ+bᵢ

gᵢ represents i^{th} low dimensional coordinates induced from the feature vector as a vector.

In some cases, a transformation function formed of any one of Aᵢ and bᵢ may be used.

The orthogonal matrix has a property as shown below.

Aᵢ^{T}Aᵢ=AᵢAᵢ^{T}=I

When the affine transformation is used, an advantage is held in that before and after the transformation, the Euclidean distance between the gallery feature vector and the low-dimensional coordinates induced from the probe feature vector is not changed, as shown in Equation below. Accordingly, when the affine transformation is used, the basic principle of the present invention may be used.

$$\begin{matrix}{‖ {T}_{i} ( {g}_{i} ) - {T}_{i} ( {p}_{i} ) ‖}^{2} = {‖ {A}_{i} {g}_{i} + {b}_{i} - {A}_{i} {p}_{i} - {b}_{i} ‖}^{2} \\ = {‖ {A}_{i} {g}_{i} - {A}_{i} {p}_{i} ‖}^{2} \\ = {( {A}_{i} {g}_{i} - {A}_{i} {p}_{i} )}^{T} ( {A}_{i} {g}_{i} - {A}_{i} {p}_{i} ) \\ = {( {g}_{i} - {p}_{i} )}^{T} {A}_{i}^{T} {A}_{i} ( {g}_{i} - {p}_{i} ) \\ = {( {g}_{i} - {p}_{i} )}^{T} ( {g}_{i} - {p}_{i} ) \\ = {‖ {g}_{i} - {p}_{i} ‖}^{2}\end{matrix}$$

As another advantage for using the transformation functions described above, when the probe feature vector is transmitted to an authentication or a recognition system, the probe feature vector is converted and transmitted so that original information of the probe feature vector is not exposed. Thus, there exists an advantage in terms of security.

In addition, in case of biometrics, since each different kind of transformation is used in each different biometric system, the templates having biometric information of the same user may have different forms depending on systems and thus, another advantage exists in terms of security and privacy.

Moreover, the user should accurately provide correct biometric information and transformation functions to the system as secret information so as to be recognized as an authenticated user or a genuine. Thus, error recognition rate may be reduced, compared with when only biometric information is used. Accordingly, the transformation function for transforming the coordinates may be used not only for separating the overlapped real regions from each other but also for increasing security.

As described above, the affine transformation function is applied to the low-dimensional coordinates induced from the feature vector. However, even if the affine transformation is directly applied to the original feature vector and the low-dimensional coordinates are induced from the converted feature vector thereafter, the user may be able to obtain the same result as that obtained by applying a coordinate transformation function separately to the low-dimensional coordinate.

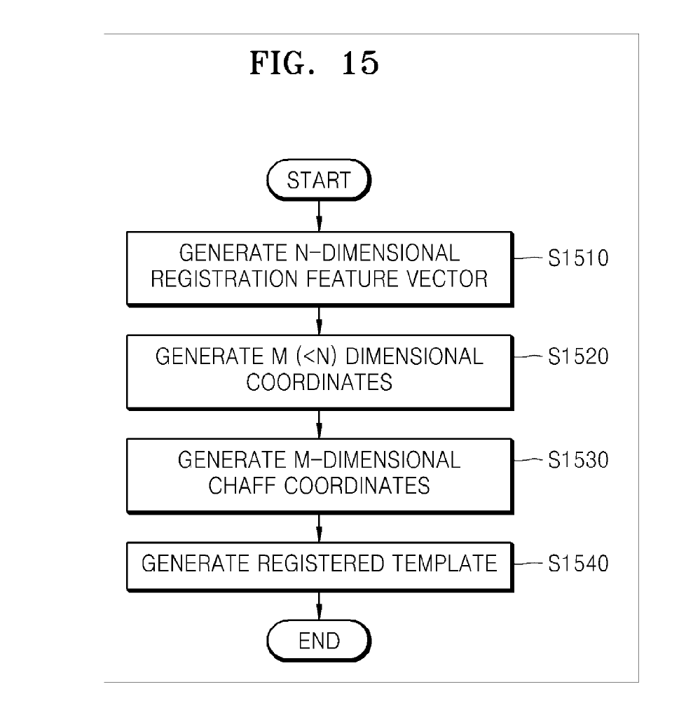

When the real regions are overlapped as in FIG. 10, a following method may be used as a solution. Instead of sharing one coordinate space by each low-dimensional coordinates, each different coordinate space is used as in FIG. 14.

FIG. 14A illustrates an example where the low dimensional coordinates induced from the feature vector use each different coordinate space. FIG. 14B illustrates registered templates including the low dimensional coordinates using each different coordinate space according to FIG. 14A.

When the probe feature vector is input for comparison and authentication, the low-dimensional coordinates (p₁, p₂) and (p₃, p₄) may respectively find regions to be included in a first coordinate space and a second coordinate space.

Here, if the user makes the order of the coordinate spaces random and makes the order managed as secret information of him or her, the security level is increased significantly. Thus, each different low-dimensional coordinate space is generated and then, the order of the coordinate spaces may be randomly arranged not only for separating the overlapped real regions from each other but also for increasing security level.

Randomly arranging the order of the coordinate spaces is equivalent to randomly arranging the order of elements of the feature vector in advance. That is, after the order of the elements of the gallery feature vector is randomly arranged as follows, the low-dimensional coordinates are induced from the feature vector, in which the order of the elements is rearranged, and the principle of the present invention is applied.

g=[g₁, g₂, g₃, g₄]^{T}−>g=[g₃, g₂, g₄, g₁]^{T}

The elements of the probe feature vector input for comparison and authentication are rearranged in the same manner as in the gallery feature vector and then, the principle of the present invention is applied for comparison and authentication.

p=[p₁, p₂, p₃, p₄]^{T}−>p=[p₃, p₂, p₄, p₁]^{T}

As mentioned above, when the arrangement order of the feature vector is managed as the user's secret information in the biometric system, correct biometric information and arrangement order of the feature vector may be accurately input so as to be recognized as the genuine so that the error recognition rate may be reduced, compared with when only biometric information is used and the security level may be increased.

For the accuracy of description and for better understanding, the four-dimensional feature vector and the 2-low dimensional coordinates induced from the four-dimensional feature vector are described as above. However, the principle of the present invention may also be applied to arbitrary low-dimensional coordinates for an arbitrary high-dimensional feature vector.

FIG. 15 is a flowchart illustrating a method of generating the registered template according to an embodiment of the present invention.

In operation 1510, n-dimensional (here n>=2) registration feature vector g (g=[g₁, g₂, . . . , gₙ]^{T}) is generated. The registration feature vector is then converted into low-dimensional coordinates to facilitate comparison and authentication, in operation 1520. That is, a positive number m (m<n) low-dimensional coordinates are generated from the registration feature vector, wherein the positive number is smaller than the positive number n. When low-dimensional coordinate points are not sufficient for generating the low-dimensional coordinates, arbitrary values k1, k2, . . . may be added. Then, a plurality of chaff coordinates are generated on the m-dimensional coordinate axis with respect to the low-dimensional coordinates, in order to complete the registered template, in operation 1530.

In operation 1540, the registered template including the low-dimensional coordinates and the chaff coordinates is generated.

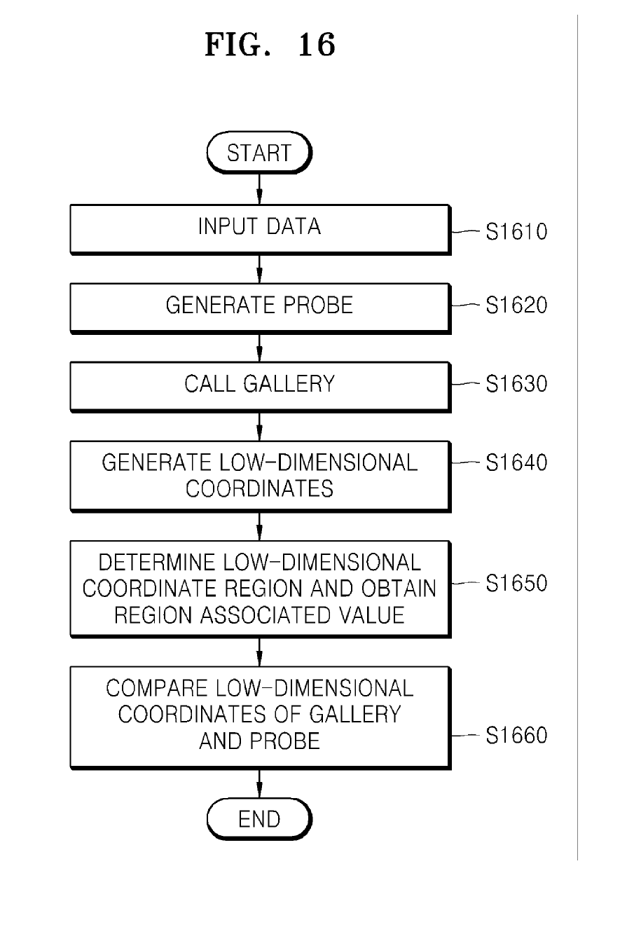

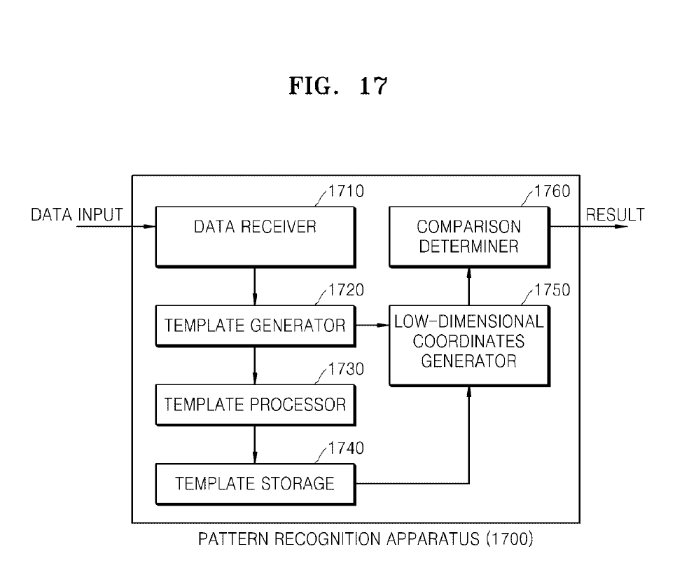

FIG. 16 is a flowchart illustrating a method of classifying whether input data is a genuine or an imposter when data to be compared is input according to an embodiment of the present invention.

When the registered template is stored, data to be compared is input. The data to be compared may be fingerprint recognition or iris recognition. Also, other formed data, instead of such biometric data, may be used.

When the data to be compared is received, in operation 1610, the data is converted into a template for pattern recognition and a probe is generated, in operation 1620. Then, a gallery is called for classifying whether the probe is the genuine or the impostor using the probe feature vector and previously registered and stored registered template, in operation 1630.

In operation 1640, low-dimensional coordinates are generated from the probe feature vector. Then, the region to which the low-dimensional coordinates of the probe belong is determined and a region associated value (or center point) of the region is obtained, in operation 1650. The region associated value (or center point) is compared with the coordinates of the probe, in operation 1660. The comparison method may include comparing a distance between two coordinate points. That is, whether the probe feature vector is located inside the genuine decision boundary, is tightly examined.

If the low-dimensional coordinates of the probe are included in the genuine decision boundary the probe is determined as the genuine, otherwise, the probe is determined as the impostor.

FIG. 17 is a block diagram of a pattern recognition apparatus 1700 according to an embodiment of the present invention.

The pattern recognition apparatus 1700 includes a data receiver 1710, a template generator 1720, a template processor 1730, a template storage 1740, a low-dimensional coordinates generator 1750, and a comparison determiner 1760.

The data receiver 1710 receives data for pattern recognition. The input data is converted into a template by the template generator 1720. The template processor 1730 determines a region of the template generated by the template generator 1720, obtains the center point (center coordinate) of the region, and calculates a hash value and coordinates of the center point. Here, the template processor 1730 further performs a function of generating a real region and a plurality of chaff regions to generate a gallery.

The template referred to as the gallery that is generated by inputting initial basis data and includes the center point, the hash value, and the coordinates to be used as a basis of the pattern recognition is generated, and the generated gallery is stored in the template storage 1740.

When data to be compared is input to the data receiver 1710, the data is converted into a probe by the template generator 1720 so as to be compared with the gallery. The template processor 1730 calculates a region of the probe, the center point of the region, and a hash value of the center point, thereby completing preparations for the comparison.

Next, the template storage 1740 calls the gallery stored in advance. Since the gallery and the probe are high-dimensional vectors, the low-dimensional coordinate generator 1750 generates the low-dimensional coordinates for each of the gallery and probe, in order to facilitate comparison and authentication. The comparison determiner 1760 compares the generated low-dimensional coordinates of the gallery and the probe and determines whether the probe is genuine or impostor.

As described above, the present invention provides a secure data storage and management method in consideration of data variability. More specifically, the present invention provides a data protection technique that converts original data into a secure form so that even if data registered to a system or database is leaked, information relating to original data cannot be exposed from the leaked data. The present invention also provides a pattern recognition method, where data comparison/recognition is possible in a data converted state, without restoring the original data from the converted data, for secure data management. The present invention also provides a data encryption and decryption method of securely storing and releasing secret information by using a variable value, instead of a fixed value

The method of converting and recognizing data according to the present invention has the following advantages.

First, data can be converted into a secure form. Specifically, as the number of dimensions of data to be converted is increased linearly, computation complexity for finding original data from the converted data is exponentially increased. Therefore, acquiring the original data is impossible even if the converted data is leaked. As a result, the data are protected in the secure form.

Second, comparison, authentication, or recognition can be performed in a state where the original data is securely converted. Therefore, the original data does not need to be restored to perform the comparison, authentication, or recognition. Therefore, unlike a data protection method using an existing cryptography method, original data do not need to be decoded and original data leakage can be prevented.

Finally, although the converted data is used to perform the comparison, authentication, and recognition, the same recognition and authentication results and performances can be maintained as in a case where the original data of the converted data is used.

When the aforementioned method is applied to a biometric system, specific advantages can be obtained as follows.

First, biometric information on a user cannot be construed from a proposed template, so that privacy intrusion of the user can be avoided.

Second, unlike a method of encoding, storing, and managing biometric information, an operation of decoding the biometric information is not required for a template comparison operation. Specifically, in a state where the biometric information on the user is securely stored, user authentication can be performed by directly comparing a gallery and a probe of the user.

Third, the present invention is not limited to a specific biometric method or a system, and can be applied to various biometric modalities without changing a unique method of an existing system.

Last, secret information such as a password and a passkey can be released while being concealed by using the biometric information on the user.

According to the present invention, even if a dimension of the registered template and the probe feature vector is increased, the low-dimensional coordinates thereof are generated and compared with each other, thereby increasing the security level and facilitating comparison between the original data and the input data.

The invention can also be embodied as computer readable codes on a computer readable recording medium. The computer readable recording medium is any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet).

The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

According to the present invention, a method of securely protecting data and a comparison/recognition method are described. In addition, the method of converting biometric information into a secure form and protecting the biometric information, a user authentication/recognition method, and the method of securely storing/releasing secret information using the biometric information are described by applying the principle of the present invention in more detail. As described above, the principle of the present invention and methods of protecting data and generating the secure template are not limited to specific biometric information and it would have been obvious to one of ordinary skill in the art, to which present invention pertains such as pattern recognition or biometrics, to apply the principle and the methods to various pattern recognition data. The scope of the invention may not be limited to specific kind of data.

It should be noted that terms from biometric technology are used for the convenience of description, because the technical concepts and terms from biometric technology among pattern recognition applications are well defined. Also, it is deemed that if the present invention is applied to a biometric system, the biometric system has a ripple effect that is higher than any other application system.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of generating a template for protecting data, the method comprising:
generating a positive numbered (n) registration feature vector g (g=[g₁, g₂, gₙ]^{T});
generating a positive number m (m<n) low-dimensional coordinates from the registration feature vector, wherein the positive number is smaller than the positive number n;
generating at least one chaff coordinates on the m-dimensional coordinate axis with respect to the generated low-dimensional coordinates; and
generating a registered template including the generated low-dimensional coordinates and the generated chaff coordinates.

2. The method of claim 1, wherein the m low-dimensional coordinates are created by adding arbitrary values to the low-dimensional coordinates, when the generated low-dimensional coordinates are not sufficient for the m-dimension.

3. The method of claim 1, wherein the registered template further comprises a hash value of the registration feature vector g.

4. The method of claim 3, wherein the hash value is generated by combining an arbitrary value to the registration feature vector g.

5. The method of claim 1, wherein the generated low-dimensional coordinates further comprise secret information to be protected and the chaff coordinates further comprises an arbitrary value for correcting an increase in the dimension of the low-dimensional coordinates due to the addition of the secret information.

6. The method of claim 5, wherein the secret information is a private key or a password.

7. A secure pattern recognition method comprising:
receiving data for pattern recognition, converting the data into a template, and generating a n-dimensional probe formed of n elements (n≧2, n is a positive number);
accessing a gallery that is a registered template including k (k≧2) low-dimensional coordinates in a m-dimension (m<n);
generating k (k≧2) low-dimensional coordinates in a m-dimension (m<n) with the probe; and
determining whether the probe and the gallery are classified into a genuine by comparing the low-dimensional coordinates of the registered template and the low-dimensional coordinates of the probe.

8. The method of claim 7, wherein the low-dimensional coordinates of the registered template and the low-dimensional coordinates of the probe are compared by calculating a Euclidean distance between the low-dimensional coordinates of the registered template and the low-dimensional coordinates of the probe feature vector.

9. The method of claim 7, wherein the low-dimensional coordinates of the registered template are set to have a radius of
$$\frac{\sqrt{m}}{\sqrt{n}} θ$$
(θ is a threshold for classifying a genuine and an impostor).

10. The method of claim 7, wherein a part or all of the low-dimensional coordinates of the registered template is transformed using transformation functions T₁, T₂ . . . Tₖ, the low-dimensional coordinates of the probe corresponding to the converted low-dimensional coordinates of the registered template are transformed using the transformation functions, and then the gallery and the probe are compared with each other.

11. The method of claim 10, wherein the transformation functions T₁, T₂ . . . Tₖ are affine transformation formed of an orthogonal matrix and a random vector.

12. The method of claim 10, wherein the low-dimensional coordinates are transformed by the transformation functions when real regions of the low-dimensional coordinates of the registered template are overlapped with each other.

13. The method of claim 7, wherein the k (k≧2) low-dimensional coordinates in the m-dimension (m<n) use k independent m-dimensional coordinate spaces.

14. The method of claim 13, wherein an order of the coordinate spaces used by the low-dimensional coordinates is randomly determined and the randomly determined order is stored separately from the registered template.

15. The method of claim 7, further comprising comparing the low-dimensional coordinates of the registered template with the low-dimensional coordinates of the probe and returning a value predetermined by the registered template to a user, when the probe and the gallery are classified into the genuine.
